(19) United States
(12) Patent Application Publication
(10) Pub. No.: US 2007/0146883 A1
(43) Pub. Date: Jun. 28, 2007

(54) OPTICAL APPARATUS

(76) Inventors: Hiroshi Akada, Yokohama-shi (JP); Masanori Ishikawa, Saitama-shi (JP); Jun Sugita, Sagamihara-shi (JP); Katsuhiro Inoue, Utsunomiya-shi (JP); Sawako Ito, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/608,296

(22) Filed: Dec. 8, 2006

(30) Foreign Application Priority Data
Dec. 9, 2005 (JP) 2005-356593

(51) Int. Cl. G02B 27/64

(52) U.S. Cl. 359/554; 396/52

(57) ABSTRACT

An optical apparatus is disclosed which is capable of acquiring images with a good quality and saving power. The optical apparatus comprises a movable unit which is supported by an elastic member and movable for image stabilization and a controller. The controller performs a first control operation which controls drive of the movable unit with respect to a first position as the center of movement where the weight of the movable unit itself and a supporting force of the elastic member are balanced, and a second control operation which controls drive of the movable unit with respect to a second position as the center of movement, the second position being shifted from the first position in the direction opposite to the gravity direction toward the optical axis of an optical system that forms an object image.

### BACKGROUND OF THE INVENTION

The present invention relates to an optical apparatus, such as an interchangeable lens and an image-pickup apparatus, equipped with an image stabilization (image-shake correction) function, and particularly to an optical apparatus that drives a movable unit, such as a lens and an image-pickup element, for image stabilization.

There have been disclosed quite a few conventional optical apparatuses equipped with an image stabilization function in which a shake sensor, such as an angular velocity sensor, detects shake caused by hand shake or the like and based on the detection result, an actuator displaces an image stabilization optical element to cancel image shake.

In such an optical apparatus equipped with an image stabilization function, Japanese Patent No. 3189018 has disclosed an approach to reduce power consumption. In this approach, the image stabilization function is activated only during image-pickup exposure operation but is not activated during aiming (finder observation or image-pickup preparation stage for determining image composition or performing autofocus and photometry operations) that generally takes longer than the image-pickup exposure operation.

Japanese Patent Laid-Open No. H08-6088 has disclosed an optical apparatus in which a movable unit including an image stabilization optical element is supported by an elastic member such that the optical center of the movable unit that has been lowered by its own weight coincides with the optical axis of the primary optical system.

However, in the optical apparatus disclosed in Japanese Patent No. 3189018, the operator cannot disadvantageously check whether or not the image stabilization is performed during aiming in the finder. If the image stabilization functions during aiming, not only can the operator accurately capture a subject (an object) in the finder, but also advantages can be expected, such as eliminating such a situation that overreaction of the operator who tries to forcefully suppress hand shake undesirably results in increased hand shake. Thus, activating the image stabilization function only during image-pickup exposure results in a significant disadvantage.

In the optical apparatus disclosed in Japanese Patent Laid-Open No. H08-6088, although the center of the image stabilization optical element may coincide with the optical axis of the primary optical system in a specific position (for example, the position in which the optical axis orients in the horizontal direction), it is likely that the same state will not be obtained in other positions (for example, the position in which the optical axis orients in the upward or downward direction). In this case, the image stabilization optical element will become stable with the center thereof displaced from the optical axis of the primary optical system, inevitably resulting in reduced quality of finder images and picked-up images.

### BRIEF SUMMARY OF THE INVENTION

The present invention provides an optical apparatus capable of acquiring images with a good quality and saving power.

The present invention in its first aspect provides an optical apparatus comprising a movable unit which is supported by an elastic member and movable for image stabilization, and a controller which controls drive of the movable unit. The controller performs a first control operation which controls drive of the movable unit with respect to a first position as the center of movement where the weight of the movable unit itself and a supporting force of the elastic member are balanced, and a second control operation which controls drive of the movable unit with respect to a second position as the center of movement, the second position being shifted from the first position in the direction opposite to the gravity direction toward the optical axis of an optical system that forms an object image.

The present invention in its second aspect provides an image-pickup system including the above-described optical apparatus.

Other objects and features of the present invention will become readily apparent from the following description of the preferred embodiments with reference to accompanying drawings.

### BRIEF DESCRIPTION OF THE DRAWINGS

FIG. 1 is a flowchart showing the image-pickup operation of the camera system that is the first embodiment of the present invention;

FIG. 2 is a block diagram showing the configuration of the camera system of the first embodiment;

FIG. 3 is a perspective exploded view of the image stabilization unit incorporated in the camera system of the first embodiment;

FIG. 4 is a perspective view of the viscoelastic member used in the image stabilization unit in the first embodiment;

FIGS. 5A and 5B are plan views of the image stabilization unit in the first embodiment when viewed from the optical axis direction;

FIG. 6 is a block diagram showing the configuration of the control system of the image stabilization unit in the first embodiment;

FIGS. 7A to 7C are graphs showing the frequency characteristics of the displacement gain of the image stabilization unit in the first embodiment;

FIG. 8 is a graph showing the measured frequency characteristic of the displacement gain of the image stabilization unit in the first embodiment; and

FIG. 9 is a flowchart showing the image-pickup operation of the camera system that is the second embodiment of the present invention.

### DETAILED DESCRIPTION OF THE PREFERRED EMBODIMENTS

Preferable embodiments of the present invention will be described below with reference to the accompanying drawings.

### First Embodiment

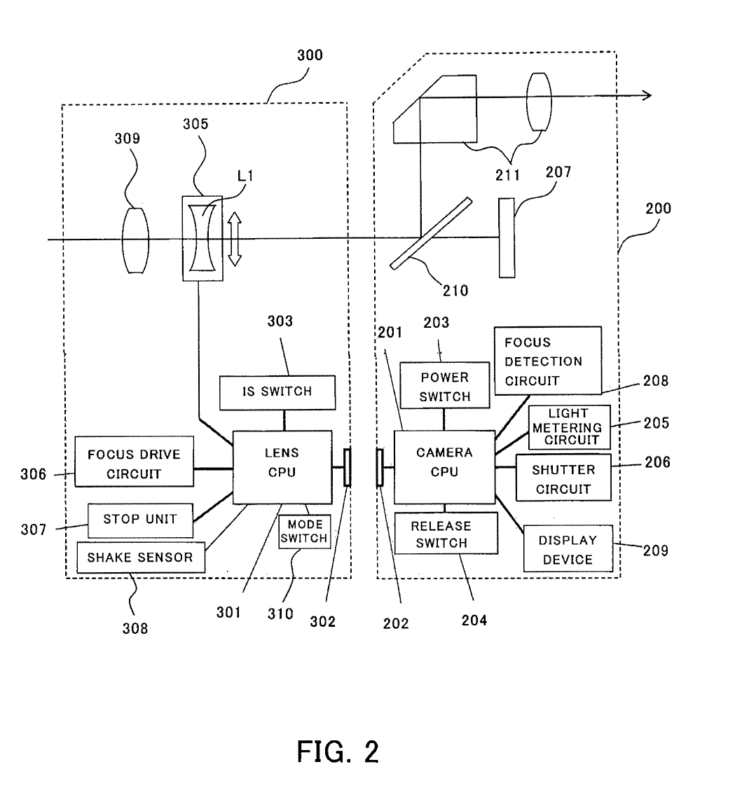

FIG. 2 shows the configuration of the image-pickup system that is the first embodiment of the present invention. The image-pickup system in this embodiment includes an interchangeable lens as an optical apparatus equipped with an image stabilization unit and a single-lens reflex digital camera as an image-pickup apparatus to and from which the interchangeable lens can be attached and detached. In FIG. 2, reference numeral 200 denotes the camera and reference numeral 300 denotes the interchangeable lens.

In the camera 200, reference numeral 211 denotes a finder optical system, and reference numeral 210 denotes a quick-return mirror for introducing light from the lens 300 to the finder optical system 211. Reference numeral 207 denotes an image-pickup element, such as a CCD sensor or a CMOS sensor, which photoelectrically converts a subject image formed by the lens 300.

Reference numeral 201 denotes a camera CPU as a camera-side microcomputer that controls the operations of various circuits in the camera 200, which will be described later. An image-pickup signal outputted from the image-pickup element 207 is inputted to an image processing circuit (not shown) formed in the camera CPU 201 where an image signal is generated based on the image-pickup signal. The camera CPU 201 communicates with a lens CPU 301 as a lens-side microcomputer, which will be described later, through a camera contact 202 and a lens contact 302.

Reference numeral 203 denotes an externally operable power switch for starting the camera CPU 201 and energizing various circuit, actuators, sensors and the like in the camera 200. Reference numeral 204 denotes an externally operable, two-stroke release switch including a first stroke switch (SW1) that will be turned on by half-pressing the release switch and a second stroke switch (SW2) that will be turned on by fully pressing the release switch.

When the first stroke switch is turned on (SW1 ON), the camera CPU 201 is switched to an image-pickup preparation stage and determines an aperture value, a shutter speed and the like based on the photometry result from a photometry circuit 205. The camera CPU 201 also calculates the drive amount of a focusing lens based on the focus detection result for the interchangeable lens (image-pickup optical system) from a focus detection circuit 208.

When the second stroke switch is turned on (SW2 ON), the camera CPU 201 sends the lens CPU 301 an instruction to drive a stop unit 307 provided in the interchangeable lens 300. The camera CPU 201 also outputs an instruction to a shutter circuit 206 to drive a shutter (not shown) and controls the image-pickup element 207 and the image processing circuit to acquire an image for recording. The recording image is recorded to a recording medium (not shown), such as a semiconductor memory and an optical disk.

Reference numeral 209 denotes a display device that displays a picked-up recording image for a predetermined period of time and also displays various image-pickup conditions, such as the aperture value and the shutter speed, as well as information on the number of picked-up images, remaining amount of the battery, various modes and the like. In the image-pickup preparation stage, the display device 209 can also display the image signal generated by the image processing circuit as an electronic finder image (image for displaying).

In the interchangeable lens 300, reference numeral 309 denotes a lens unit formed of a plurality of lenses, such as a variable magnification lens and a focusing lens.

Reference numeral 305 denotes an image stabilization unit. The image stabilization unit 305 includes the following five elements. The first element is a movable unit having a correction lens L1 as an image stabilization optical element and a correction lens frame that holds the correction lens L1. The correction lens L1 together with the lens unit 309 form the image-pickup optical system.

The second element is an image stabilization actuator that drives the movable unit in a direction perpendicular to the optical axis. The direction perpendicular to the optical axis used herein includes not only completely perpendicular directions but also directions deviated from the completely perpendicular direction to the extent of being considered to be perpendicular.

The third element is a position sensor for detecting the position of the movable unit. The fourth element is a lock mechanism capable of locking the movable unit at a predetermined position (optical axis center position) and unlocking the movable unit therefrom. The fifth element is a lock mechanism actuator for driving the lock mechanism.

In this embodiment, although a description will be made of a case where the correction lens is displaced in the direction perpendicular to the optical axis, the form of the image stabilization unit in the present invention is not limited thereto. For example, the present invention can also be applied to a case where image stabilization is achieved by swinging the correction lens with respect to a point on the optical axis as the swing center.

Reference numeral 303 denotes an externally operable image stabilization switch (hereinafter referred to as an IS switch) that is operated to select whether or not to drive the image stabilization unit 305 to perform an image stabilization operation as an image-shake correction operation.

Reference numeral 308 denotes a shake sensor that detects the vertical (pitch) and horizontal (yaw) shakes of the interchangeable lens 300, that is, the image-pickup system, and is formed of an angular velocity sensor or an acceleration sensor. The lens CPU 301 controls and drives the image stabilization unit 305 based on the output signal from the shake sensor 308.

Reference numeral 306 denotes a focus drive circuit that drives the focusing lens incorporated in the lens unit 309. The lens CPU 301 receives drive amount information computed by the camera CPU 201 and outputs a drive signal to the focus drive circuit 306. The focus drive circuit 306 activates a focus actuator (not shown) that drives the focusing lens based on the drive signal.

The lens CPU 301 also drives the stop unit 307 according the stop drive instruction received from the camera CPU 201.

Reference numeral 310 denotes a mode switch. The operator can select a power-saving mode or a normal power mode by operating the mode switch 310.

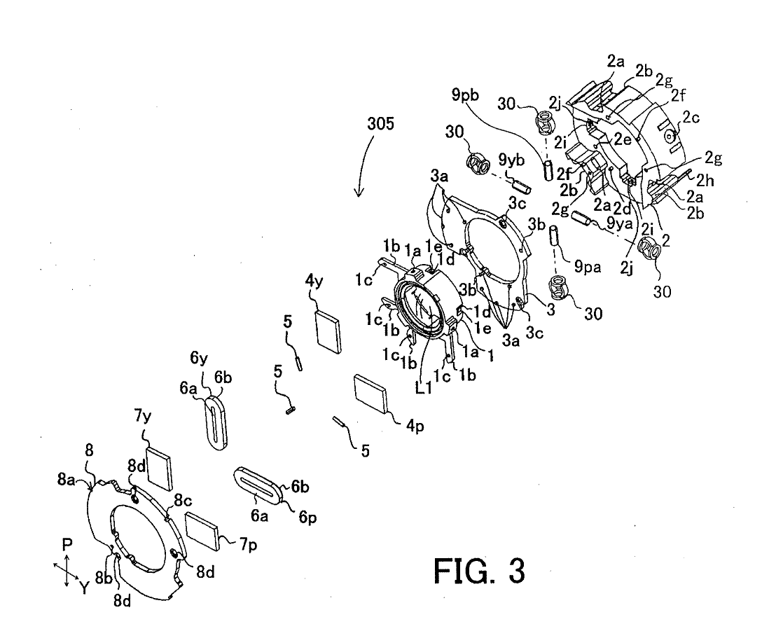

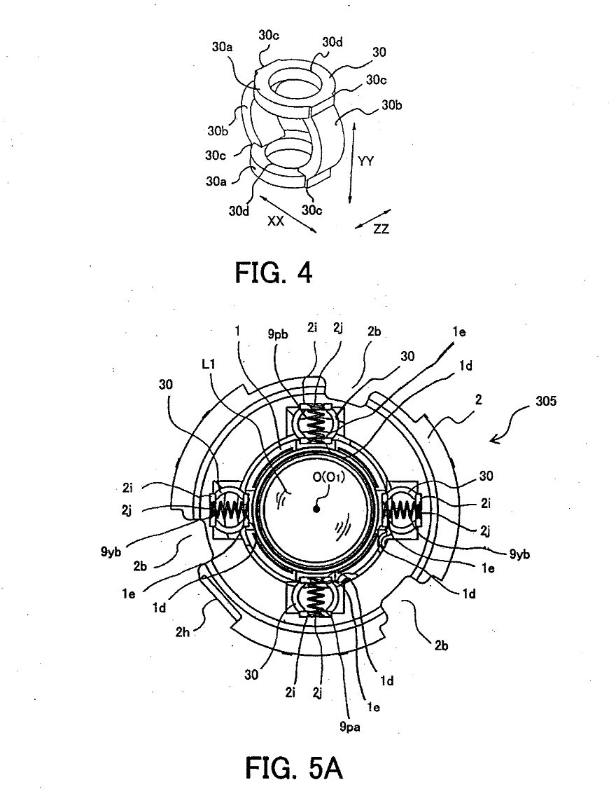

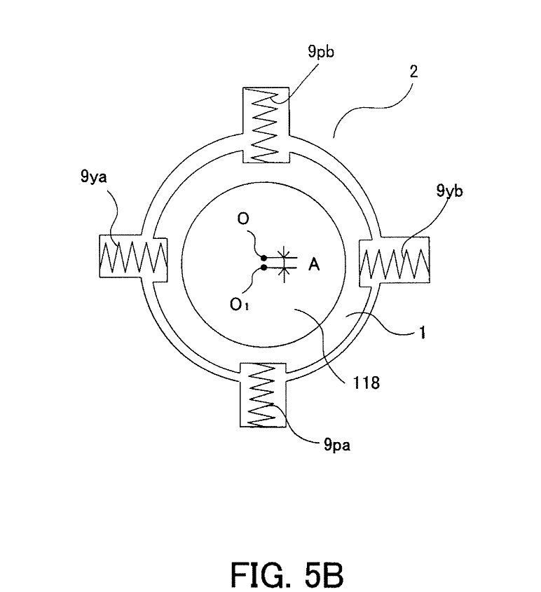

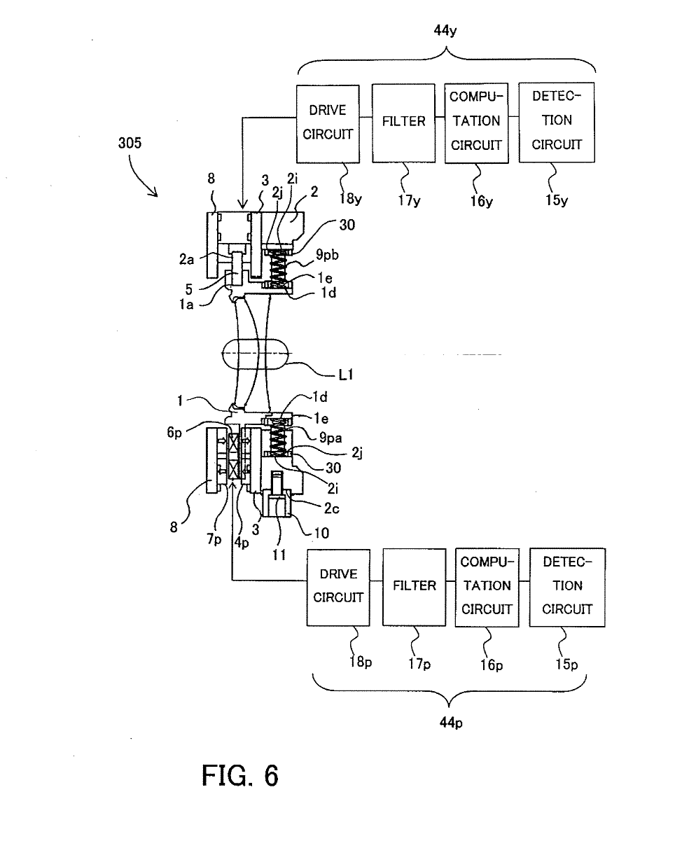

FIG. 3 is an exploded view of the image stabilization unit in this embodiment. FIG. 4 shows a viscoelastic member (elastic member) used in the image stabilization unit. FIGS. 5A and 5B show the image stabilization unit when viewed from the optical axis direction. FIG. 6 shows the cross section of the image stabilization unit as well as a drive control system of the image stabilization unit.

In these figures, reference numeral 1 denotes the correction lens frame that holds the correction lens L1. Reference numeral 2 denotes a base member that is a base of the image stabilization unit. The correction lens frame 1 integral with the correction lens L1 moves in the pitch and yaw directions relative to the base member 2 for image stabilization.

Elongated holes 2a extending in the circumferential direction are formed in the base member 2 at three circumferential locations. Pins 5 are press fitted into holes 1a formed in the correction lens frame 1 at three circumferential locations. Each of the pins 5 is inserted in the elongated hole 2a. In this way, the correction lens frame 1 is held in the base member 2 such that the correction lens frame 1 cannot move in the optical axis direction but can shift in the pitch and yaw directions.

Holes 2c for securing the base member 2 in the lens 300 are formed in the outer side of the base member 2 at three circumferential locations. As shown in FIG. 6, rollers 10 are inserted into the holes 2c, fastened with screws 11 and engaged with a fixed member (not shown) in the lens 300, allowing the base member 2 to be secured in the lens 300. If one or two of the three rollers 10 are eccentric rollers, rotating the eccentric roller(s) allows inclination adjustment of the base member 2 in the lens 300.

Reference numerals 4p and 4y denote first magnets for the pitch and yaw directions, respectively, each of which is magnetically coupled to a first yoke 3. Reference numerals 7p and 7y denote second magnets for the pitch and yaw directions, respectively, each of which is magnetically coupled to a second yoke 8. Both of the first magnets 4p and 4y are positioned relative to the first yoke 3 by means of projections 3a provided on the first yoke 3. Similarly, the second magnets 7p and 7y are positioned relative to the second yoke 8 by means of projections (not shown) provided on the second yoke 8.

As shown in FIG. 6, each of these magnets 4p, 4y, 7p and 7y (only the magnets 4p and 7p are shown in FIG. 6) is magnetized such that the magnetic direction in the portion proximal to the center of the image stabilization unit differs from the magnetic direction in the distal portion and the portion around the center of each magnet is a non-magnetized neutral zone, so as to efficiently generate a driving force by aligning the winding position of a coil, disposed such that the coil faces each magnet in the optical axis direction, with the magnetized zone of each magnet.

The first yoke 3 together with the first magnets 4p and 4y are positioned relative to the base member 2 by inserting two projections 2d provided on the base member 2 into two holes 3b formed in the first yoke 3. The first yoke 3 is then fixed to the base member 2 by fastening screws through three holes 3c formed in the first yoke 3 and three holes 2e formed in the base member 2 (only one hole 2e is shown in FIG. 3). It should be noted that the first yoke 3 is fixed before the pins 5 are press fitted into the correction lens frame 1.

The second yoke 8 is fixed to the base member 2 by inserting two projections 2f formed on the base member 2 into a hole 8b and a recess 8c formed in the second yoke 8. The second yoke 8 is then fixed to the base member 2 by fastening screws through holes 8d formed in the second yoke 8 and holes 2g formed in the base member 2.

Reference numerals 6p and 6y denote drive coils for the pitch and yaw directions, each of which includes a winding (coil) portion 6a formed of a conductive member and a support portion 6b made of resin to be fixed to the correction lens frame 1. Each of the coils 6p and 6y is positioned relative to the correction lens frame 1 by abutting the support portion 6b against an arm 1b provided on the correction lens frame 1 and inserting a projection lc on the correction lens frame 1 into a hole (not shown) provided in the support portion 6b. The thus positioned coils 6p and 6y are fixed to the correction lens frame 1 with an adhesive.

The first yoke 3, the first magnets 4p and 4y, the second magnets 7p and 7y, and the second yoke 8 form a closed magnetic circuit, and the coil portions 6a of the coils 6p and 6y are disposed in the closed magnetic circuit. The coils 6p and 6y are energized to drive the movable unit formed of the coils 6p and 6y, the correction lens frame 1 and the correction lens L1 relative to the base member 2 in the pitch direction P and the yaw direction Y.

The coils 6p and 6y are energized through a flexible circuit board (not shown) on which electronic parts required for driving the image stabilization unit are mounted. The flexible circuit board is fixed to the front side of the second yoke 8 or the rear side of the base member 2 and has a connecting portion for connecting the flexible circuit board to another circuit board. A receptacle for this connecting portion is formed as an extension 2h on the base member 2, and the connecting portion is fixed to the extension 2h by means of a double-sided adhesive tape or the like.

Reference numerals 9pa and 9pb are pitch-direction compression coil springs as elastic members having elasticity in the pitch direction, and they are disposed at two locations in the pitch direction between the correction lens frame 1 and the base member 2. Reference numerals 9ya and 9yb are yaw-direction compression coil springs as elastic members having elasticity in the yaw direction, and they are disposed at two locations in the yaw direction between the correction lens frame 1 and the base member 2. The optical axis-side end of each of the coil springs abuts a flat portion 1d provided on the correction lens frame 1, and each of projections 1e on the correction lens frame 1 is inserted into each of the coil springs and functions to prevent disengagement of each of the coil springs.

The outer end of each of the coil springs abuts a flat portion 2i formed on the base member 2, and each of projections 2j on the base member 2 is inserted into each of the coil springs and functions to prevent disengagement of each of the coil springs.

The compression coil springs 9pa, 9pb, 9ya and 9yb are compressed when assembled as shown in FIGS. 5A, 5B and 6. Thus, the movable unit including the correction lens L1 and the correction lens frame 1 is supported in an elastically suspended state relative to the base member 2 in the pitch and yaw directions.

Reference numeral 30 denotes viscoelastic members made of self-damping rubber, which are disposed such that each of them surrounds each of the compression coil springs 9pa, 9pb, 9ya and 9yb.

The detailed configuration of the viscoelastic member 30 will be described with reference to FIG. 4. The XX, YY and ZZ directions in FIG. 4 denote the yaw, pitch and optical axis directions, respectively.

The viscoelastic member 30 is generally and roughly shaped into a ring when viewed from the optical axis direction so as to provide similar viscoelasticity when deformed in either of the pitch and yaw directions.

Reference numeral 30a denotes an attachment portion and two attachment portions are provided (at both ends) in the vertical direction (YY direction) in the figure. In FIG. 5A, the optical axis-side attachment portion 30a is press fitted into a recess in the correction lens frame 1 and abuts the flat portion 1d that is the bottom of the recess.

In FIG. 5A, the attachment portion 30a opposite to the optical axis is press fitted into a recess in the base member 2 and abuts the flat portion 2i that is the bottom of the recess.

The attachment portion 30a is provided with projections 30c, which tightly abut the inner circumference walls of the recess, thereby preventing the rotation of the viscoelastic member 30.

In addition to press fitting the attachment portion 30a as described above, it may be fixed to the correction lens frame 1 and the base member 2 using an elastic adhesive, such as a silicon-based adhesive.

Reference numeral 30b denotes side portions each shaped into a strip for connecting the right ends or left ends (XX-direction ends) of the upper and lower attachment portions 30a in FIG. 4. In this embodiment, the side portion 30b is curved and outwardly convex. This provides similar viscoelasticity even when the upper and lower attachment portions 30a are shifted from each other in the XX or YY direction.

The side portion 30b is formed such that the width dimension in the ZZ direction is greater than the thickness dimension in the XX direction. Thus, the viscoelastic member 30 is more resistant to deformation in the optical axis direction than in the pitch and yaw directions, thereby preventing the displacement of the correction lens frame 1 in the optical axis direction.

Furthermore, a hole 30d having an inner diameter larger than the outer diameter of each compression coil spring (9pa, 9pb, 9ya or 9yb) is formed at the center of each attachment portion 30a. This prevents interference between each viscoelastic member 30 and each compression coil spring (9pa, 9pb, 9ya or 9yb) inserted in the holes 30d.

According to the above configuration, when each of the coils 6p and 6y is energized to generate thrust against the elastic forces of the compression coil springs so as to drive the correction lens frame 1 (hence the correction lens L1) in the pitch direction or in the yaw direction, the viscoelastic member 30 provides a required damping effect to the correction lens frame 1.

Compared to a case where viscosity of a viscous fluid is used, a uniform damping effect is provided regardless of the shake-correction direction, thereby eliminating concerns for change in viscosity and running out of the fluid due to aging and temperature.

Also, by changing the material or shape of the viscoelastic member 30 (for example, by changing the curvature or thickness of the side portion 30b), the viscoelasticity (hence the damping effect characteristic) can be easily adjusted.

Although not shown in the drawings, the image stabilization unit in this embodiment is provided with a position detector in order to detect the position of the correction lens L1. Specifically, the position detector formed of a target member for position detection and a photo-reflector disclosed in Japanese Patent Laid-Open No. H11-212133 can be used. Alternatively, the position detector formed of a light emitting element, such as an LED, and a light receiving element, such as a PSD, disclosed in Japanese Patent Laid-Open No. 2005-227329 may be used.

In this embodiment, the voltage (power) inputted to each of the coils 6p and 6y corresponds to a target position for image stabilization, and the drive target value for each of the coils 6p and 6y is set based on the detection output from the shake sensor 308 and the detection output from the above-mentioned position detector.

The coil springs 9pa, 9pb, 9ya and 9yb have linear elasticity and the characteristic of the thrust generated by each of the coils 6p and 6y is also linear to the input voltage. Thus, when the elastic constants of the coil springs (the elastic force versus displacement characteristics) and thrust constants of the coils (the thrust versus input voltage characteristics) are known in advance, desired amounts of displacement can be provided to the correction lens L1 by adjusting the input voltages. Therefore, the position detector for detecting the position of the correction lens L1 may be eliminated.

When the image stabilization function is not used (when the IS switch 303 is turned off), the image stabilization unit 305 in this embodiment does not require the lock mechanism for locking and holding the correction lens L1 at a second position, which will be described later. A rolling prevention mechanism for preventing inclination of the correction lens L1 with respect to the optical axis is also not required. Therefore, a significantly simple configuration of the image stabilization unit can be achieved.

FIGS. 5A and 5B show the movable unit supported by the coil springs 9pa, 9pb, 9ya and 9yb when viewed from the optical axis direction. In FIG. 5B, the viscoelastic members 30 are omitted.

As shown in FIG. 5A, the coil 6p is energized at a predetermined power level to hold the movable unit including the correction lens frame 1 and the correction lens L1 at a position where the center O₁ of the movable unit coincides with the optical axis center O of the image-pickup optical system. This position obtained by energizing the coil is hereinafter referred to as the second position. The position where the center O₁ coincides with the optical axis center O used herein includes not only the position where the two centers completely coincide with each other but also positions that are considered as coincident in terms of optical performance.

On the other hand, as shown in FIG. 5B, when the coil 6p is not energized, the movable unit is held at the position where the center O₁ of the movable unit is lowered by A from the optical axis center O according to the relationship between the mass of the movable unit (the weight of the movable unit itself) and the spring loads acting mainly on the coil springs 9pa and 9pb. That is, the movable unit is held at the position where balance is achieved between the weight of the movable unit itself and the supporting forces by the coil springs 9pa and 9pb. The lowered position due to the weight of the movable unit itself is referred to as the first position.

When the movable unit is situated at the first position, the optical axis of the image-pickup optical system is slightly inclined, so that the image position on the image-pickup element slightly shifts from the image position when the movable unit is situated at the second position. The image resulting from the image stabilization operation for the correction lens L1 with respect to the first position as the center of movement may be potentially degraded compared to the image resulting from the image stabilization operation for the correction lens L1 with respect to the second position as the center of movement.

However, the degree of image degradation is not significant, so that the degradation will not be a significant problem when observing a subject through the finder optical system 211 or the electronic finder image during the image-pickup preparation stage for photometry and autofocus operations. Furthermore, the power consumption can be reduced compared to the case where the coil 6p is energized to lift the movable unit to the second position for the subsequent image stabilization operation.

Accordingly, in this embodiment, during the image-pickup preparation stage in which the image stabilization operation is performed not for acquiring recording images and when the operator wants to save power consumption, the image stabilization operation for the correction lens L1 is performed with respect to the first position as the center of movement. On the other hand, during acquisition of recording images in which high-quality images are typically desired, the image stabilization operation is performed with respect to the optical axis center O as the center of movement as shown in FIG. 5A.

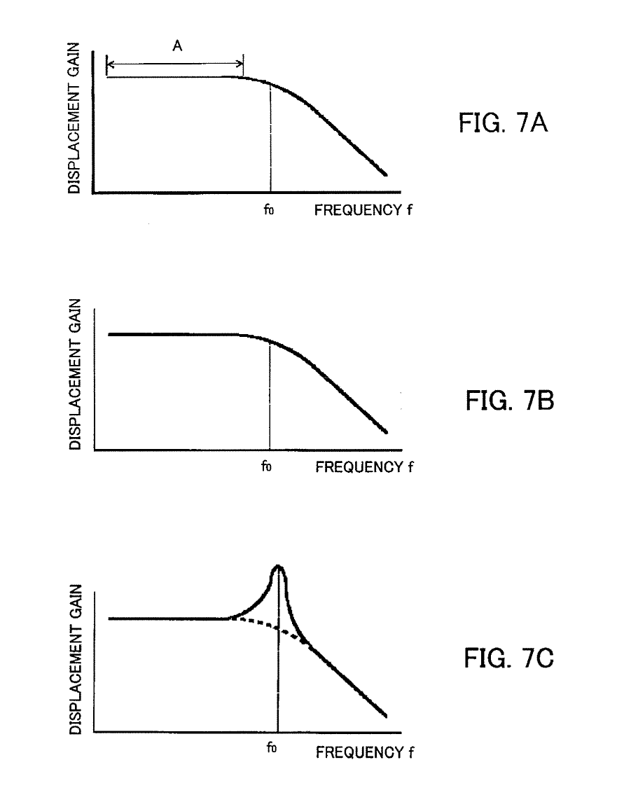

Next, a description will be made of a frequency characteristic of the vibration system formed of the correction lens L1 (correction lens frame 1) and the compression coil springs 9pa, 9pb, 9ya and 9yb with reference to FIGS. 7A to 7C.

As shown in the Bode diagram of FIG. 7A, the frequency characteristic of the vibration system is such that the displacement gain decreases (is attenuated) at the frequencies equal to or higher than the natural frequency f0 of the vibration system. That is, the vibration system has a characteristic in which the drive amount of the correction lens L1 for target values inputted to the coils 6p and 6y decreases to the point where the shake correction cannot be performed. The natural frequency f0 is determined by the spring constants of the compression coil springs and the weights resulting mainly from the correction lens L1 and the correction lens frame 1.

The natural frequency f0 is set to be higher than the typical hand-shake frequency band (about 1 to 12 Hz) A so that the attenuation region described above (the region where the shake correction cannot be performed) does not overlap with a shake-correction band (that is, the hand-shake frequency band).

In the actual image-pickup operation of the camera with the image stabilization unit installed therein, shakes are generated at frequencies higher than the shake-correction band described above, such as vibrations when the quick return mirror is actuated (hereinafter referred to as a mirror shake) or vibrations when the shutter is driven (hereinafter referred to as a shutter shake).

The effect of the mirror shake and shutter shake can be eliminated by setting the natural frequency f0 to be higher than these shakes. However, in this case, the spring constants of the compression coil springs need to be larger to increase the natural frequency f0. This requires greater electric power and magnetic force to drive the correction lens L1, resulting in a larger image stabilization unit and increased power consumption.

In general, such a mirror shake and shutter shake are small, so that they are not problematic in most image-pickup operations without shake correction. However, when these shakes are detected by the shake sensor, the output from the shake sensor is inputted to the coils 6p and 6y as a drive target value, resulting in the following problems.

As shown in FIG. 7A, for the frequencies equal to or higher than the natural frequency f0, not only does the displacement gain of the correction lens L1 decrease but also the phase is delayed. Thus, the driving operation of the correction lens L1 in response to the target value input will be delayed.

Furthermore, when the amount of the delay in response is large, not only is the image shake not corrected by the movement of the correction lens L1, but also the amount of the image shake increases. That is, the correction lens L1 moves such that it undesirably increases the shake, in contrast to the original intention of canceling the shake by moving the correction lens L1. Thus, the image shake due to the mirror shake or the shutter shake becomes larger when the image stabilization operation is performed than when not performed, which could degrade images.

To avoid this problem, as shown in the configuration diagram of FIG. 6 and the Bode diagram of FIG. 7B, the detection outputs from the shake sensors (detection circuits 15p and 15y) are connected to filters 17p and 17y that lower target value gains for the frequencies equal to or higher than the natural frequency f0. The filters 17p and 17y serve to lower (attenuate) the target value gain for the mirror shake or the shutter shake. This together with the frequency characteristic of the vibration system itself shown in FIG. 7A in which the displacement gain decreases at the natural frequency f0 or higher make the image stabilization unit non-responsive to the mirror shake and the shutter shake, thereby preventing the image degradation described above.

Next, a description will be made of how to actually set drive target values inputted to the coils 6p and 6y with reference to FIG. 6. The detection outputs from the shake sensors (detection circuits 15p and 15y) are inputted to computation circuits 16p and 16y. The computation circuits 16p and 16y convert the detection outputs into drive target values appropriate to the amounts of shake correction, that is, input voltages to the coils 6p and 6y appropriate to the amounts of displacement of the correction lens L1. The input voltage to each of the coils 6p and 6y is a value that causes the image stabilization actuator to generate thrust that balances with the spring forces generated by the compression coil springs.

During the conversion, the amount of shake correction is corrected for zooming and focusing of the camera, because the amount of shake correction in the image plane resulting from the drive amount of the correction lens L1 typically changes in association with the change in focal length and focal point position.

The outputs from the computation circuits 16p and 16y are then inputted to the filters 17p and 17y. The filters 17p and 17y attenuate the component of the drive target value resulting from the mirror shake and the shutter shake based on the target gain characteristic shown in FIG. 7B.

The signals (drive target values) passing through the filters 17p and 17y are inputted to drive circuits 18p and 18y, where voltages applied to the coils 6p and 6y are generated. The drive circuits 18p and 18y generate currents sufficient for the voltages inputted to the coils 17p and 17y.

While FIG. 7B shows the frequency characteristic of the drive target value, the displacement gain versus the drive input curve of the actual vibration system abruptly rises due to the resonance phenomenon of the vibration system around at the natural frequency f0, as shown in FIG. 7C. That is, the driving speed of the shake correction lens L1 greatly increases. Thus, a drive input around at the natural frequency f0 will cause undesirable, so-called over-response.

Therefore, the displacement gain characteristic around at the natural frequency f0 of the actual vibration system needs to be a flat characteristic that smoothly changes as indicated by the dotted line shown in FIG. 7C.

Thus, in this embodiment, the viscoelastic member 30 is added to the vibration system so as to impart a damping effect to the drive operation of the correction lens L1, thereby simply and reliably providing the above characteristic.

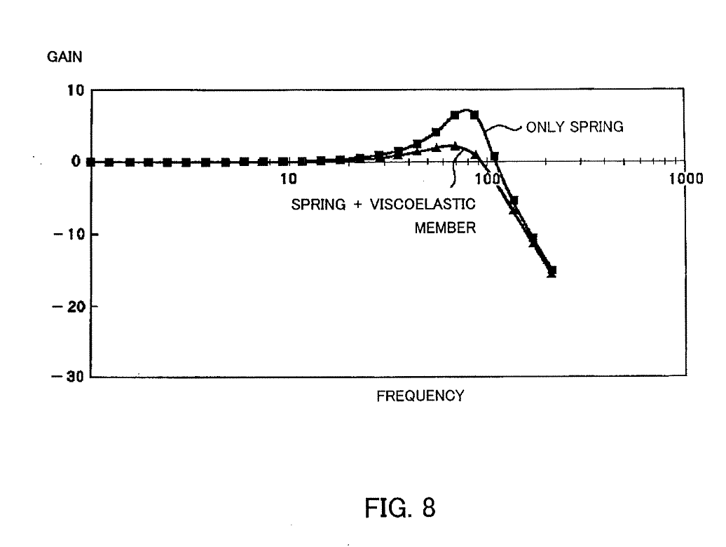

FIG. 8 shows measured frequency characteristic of the image stabilization unit in this embodiment. As will be seen from the figure, when the viscoelastic member 30 is provided (indicated by filled triangles), the peak of the gain is suppressed compared to the case where only springs are provided (indicated by filled squares).

To achieve flatter characteristic indicated by the dotted line shown in FIG. 7C, it is necessary to add an element that imparts further damping effect. However, greater damping results in reduced power saving effect and the phase delay when driving the correction lens L1 also becomes noticeable. Therefore, it is necessary to set appropriate damping in consideration of these effects.

More damping may cause phase delay when driving the correction lens L1. To improve this, an electrical compensation function of phase advance may be added.

The natural frequency f0 of the vibration system depends on the mass of the correction lens L1 and the correction lens frame 1. Thus, it is necessary to select the spring constants of the compression coil springs as well as the material and the shape of the viscoelastic member according to the mass of the correction lens L1 and the correction lens frame 1.

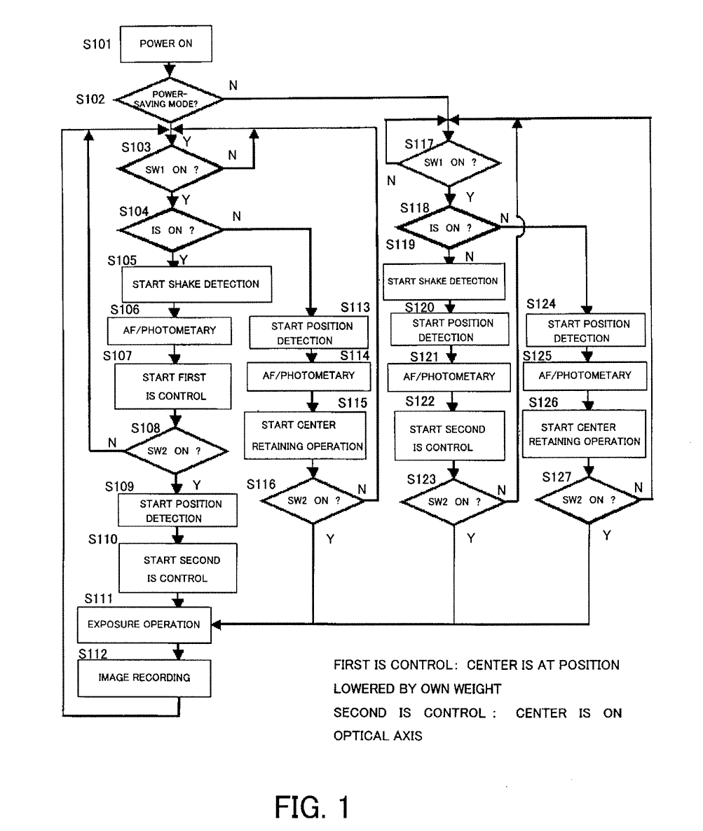

A description will be made of the image-pickup operation of the camera 200 with the interchangeable lens 300 equipped with the thus configured image stabilization unit with reference to the flowchart shown in FIG. 1. The operation shown in the flowchart is mainly executed according to a computer program stored in the camera CPU 201 and the lens CPU 301. This also applies to another embodiment described later. Reference character “S” in the figure denotes a step.

Firstly, when the camera 200 is turned on and the interchangeable lens 300 is energized (S101), the lens CPU 301 detects the state of the mode switch 310 and determines whether it is the power saving mode or the normal power mode (S102). In the power saving mode, it is determined whether or not a signal indicating that the SW1 in the release switch 204 has been turned on is inputted from the camera CPU 201 (whether or not the SW1 is ON) (S103). When the SW1 is ON, the lens CPU 301 determines whether or not the IS switch 303 is ON (S104). When the SW1 is OFF, the operation repeats S103.

When the IS 303 switch is ON, the lens CPU 301 starts detection of shake by means of the shake sensor 308 (S105). On the other hand, in the camera 200, the camera CPU 201 starts autofocus and photometry operations (S106).

In the interchangeable lens 300, the lens CPU 301 starts a first image stabilization control operation (S107) The first image stabilization control operation is an operation to perform the image stabilization operation for the movable unit (in this embodiment, formed of the correction lens L1, the correction lens frame 1, the coils 6p and 6y, and the pins 5) suspendedly supported by the compression coil springs 9pa, 9pb, 9ya and 9yb with respect to the first position mentioned above as the center of movement.

The electric power used for the image stabilization operation is largely divided into two categories. One is a center retaining power for retaining the movable unit at the optical axis center position against the gravity, and the other is a shift drive power for shifting the movable unit from that position for image-shake correction. In the first image stabilization control operation, the center of the shift operation is the first position where balance is achieved between the weight of the movable unit itself and the supporting forces of the compression coil springs, that is, the natural position where the movable unit is slightly lowered due to its own weight from the optical axis center position in the gravity direction. Therefore, as mentioned above, the center retaining power is not required, allowing a power-saving image stabilization operation.

When the SW1 is ON, the camera is not picking up images but the operator is looking at a subject through the finder, so that the image stabilization operation with respect to the first position as the center of movement will not affect the image-pickup operation.

Next, the lens CPU 301 determines whether or not a signal indicating that the SW2 in the release switch 204 has been turned on is inputted from the camera CPU 201 (whether or not the SW2 is ON) (S108). When the SW2 is ON, the lens CPU 301 starts detection of the position of the movable unit by means of the position detector (not shown) (S109) and then starts a second image stabilization control operation (S110). When the SW2 is OFF, the operation returns to S103.

The second image stabilization control operation is an operation to perform the image stabilization operation for the movable unit with respect to the second position mentioned above as the center of movement. This image stabilization operation allows an optically optimal image-pickup operation.

Upon the start of the second image stabilization control operation, the camera CPU 201 retracts the quick return mirror 210 out of the image-pickup optical path (up operation) and activates the shutter (not shown) to expose the image-pickup element 207 (S111). Then, a recording image is acquired and recorded to the recording medium (S112), and thus a series of image-pickup operations is completed.

At S104, when the IS switch 303 is OFF, the lens CPU 301 starts detection of the position of the movable unit as in S109 (S113) and the camera CPU 201 starts the autofocus and photometry operations as in S106 (S114). Then, the lens CPU 301 drives the movable unit and retains it at the second position (center retaining operation) (S115).

Upon determination that the SW2 is ON (S116), the camera CPU 201 performs the up operation of the quick return mirror 210, exposes the image-pickup element 207 (S111) and acquires a recording image and records it to the recording medium (S112). When the SW2 is OFF at S116, the operation returns to S103.

When the normal power mode is set at S102, the lens CPU 301 determines whether the SW1 is ON (S117) and whether the IS switch 303 is ON (S118) as in S103 and S104, and then starts detection of shake (S119) and detection of the position of the movable unit (S120). Then, the camera CPU 201 starts the autofocus and photometry operations (S121) as in S106. The lens CPU 301 then starts the second image stabilization control operation (S122).

Upon determination that the SW2 is ON (S123), the camera CPU 201 performs the up operation of the quick return mirror 210, exposes the image-pickup element 207 (S111) and acquires a recording image and records it to the recording medium (S112). When the SW2 is OFF at step S123, the operation returns to S117.

When the IS switch 303 is OFF at S118, the lens CPU 301 and the camera CPU 201 perform S124 to S126 as in S113 to S115, and when the SW2 is ON (S127), the operation proceeds to S111. When the SW2 is OFF at S127, the operation returns to S117.

As described above, according to this embodiment, in the power saving mode, the center of the image stabilization operation is the first position where the movable unit is slightly lowered due to its own weight from the optical axis center position in the gravity direction. Thus, power consumption for lifting the movable unit to the optical axis center position can be eliminated, allowing a power-saving image stabilization operation. During image pickup for acquiring recording images, the image stabilization operation for the movable unit is performed with respect to the second position corresponding to the optical axis center position as the center of movement, allowing an optically optimal image-pickup operation.

### Second Embodiment

In the first embodiment described above, the description has been made of a case where in the power saving mode, when the SW1 is ON, the power-saving image stabilization operation is performed with respect to the first position as the center of movement, while when the SW2 is ON, the operation is switched to the image stabilization operation for acquiring high-quality images that is performed with respect to the second position as the center of movement. However, when an image quality switching capability that allows the user to switch, for example, between a low-quality image-pickup mode and a high-quality (standard) image-pickup mode, is equipped and the low-quality image-pickup mode is selected, the image stabilization operation may be performed with respect to the first position as the center of movement not only when the SW1 is ON, but also when the SW2 is ON (during image-pickup). In this way, further power saving can be achieved.

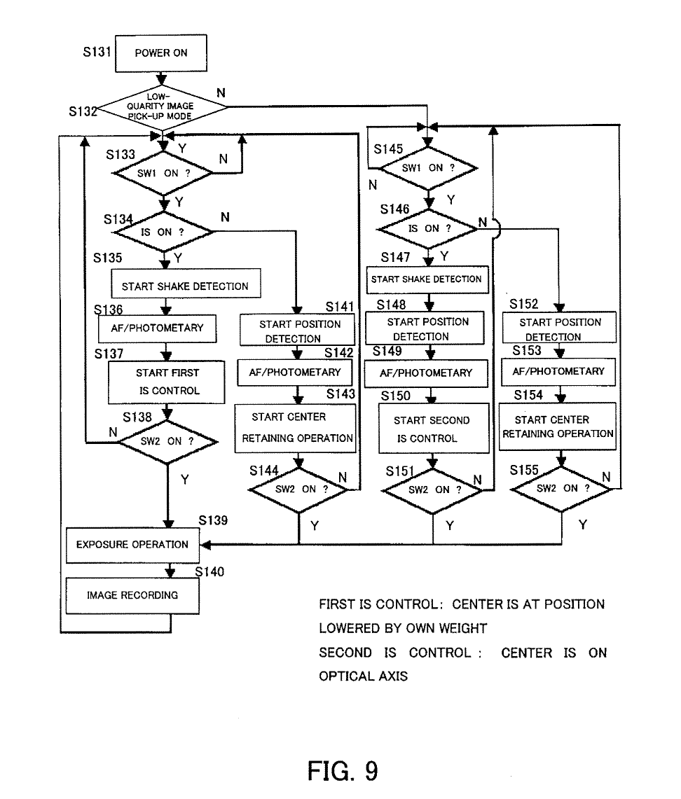

The image-pickup operation in this embodiment will be described with reference to the flowchart shown in FIG. 9. The configuration of the camera system in this embodiment is basically the same as that in the first embodiment, and the components common to those in the first embodiment have the same reference numerals. However, in this embodiment, the operation of the mode switch 310 allows selecting between the low-quality image-pickup mode and the high-quality (standard) image-pickup mode capable of picking up images with image quality higher than that obtained in the low-quality image-pickup mode.

When the camera 200 is turned on and the interchangeable lens 300 is energized (S131), the lens CPU 301 detects the state of the mode switch 310 and determines whether it is the low-quality image-pickup mode or the high-quality image-pickup mode (S132).

In the low-quality image-pickup mode, the lens CPU 301 determines whether or not a signal indicating that the SW1 in the release switch 204 has been turned on is inputted from the camera CPU 201 (whether or not the SW1 is ON) (S133). When the SW1 is ON, the lens CPU 301 determines whether or not the IS switch 303 is ON (S134) When the SW1 is OFF, the operation repeats S133.

When the IS 303 switch is ON, the lens CPU 301 starts detection of shake by means of the shake sensor 308 (S135) and the camera CPU 201 starts autofocus and photometry operations (S136). Then, the lens CPU 301 starts the first image stabilization control operation (S137).

Upon starting the detection of shake, feedback control based on the detection of the position of the movable unit will improve image stabilization performance. However, since the low-quality image-pickup mode has been set, in addition to the power saving effect obtained by the first image stabilization control operation, no position detection or feedback control allows further power saving.

Although it is conceivable that the optical performance may be slightly compromised in the first image stabilization control operation compared to that obtained in the second image stabilization control operation, power saving is given a priority because the operator has selected the low-quality image-pickup mode.

Next, the lens CPU 301 determines whether or not a signal indicating that the SW2 in the release switch 204 has been turned on is inputted from the camera CPU 201 (whether or not the SW2 is ON) (S138). When the SW2 is ON, the lens CPU 301 maintains the first image stabilization control operation. The camera CPU 201 performs the up operation of the quick return mirror 210, exposes the image-pickup element 207 (S139), acquires a recording image and records it to the recording medium (S140), and thus a series of image-pickup operations is completed. When the SW2 is OFF, the operation returns to S133.

At S134, when the IS switch 303 is OFF, the lens CPU 301 starts detection of the position of the movable unit by means of the position detector (S141) and the camera CPU 201 starts the autofocus and photometry operations (S142). Then, the lens CPU 301 drives the movable unit and retains it at the second position (center retaining operation) (S143). Upon determination that the SW2 is ON (S144), the camera CPU 201 performs the up operation of the quick return mirror 210, exposes the image-pickup element 207 (S139) and acquires a recording image and records it to the recording medium (S140). When the SW2 is OFF at S144, the operation returns to S133.

At S132, when the lens CPU 301 determines that the high-quality (standard) image-pickup mode is set, the lens CPU 301 determines whether the SW1 is ON (S145) and whether the IS switch 303 is ON (S146) as in S133 and S134. When the SW1 and the IS switch 303 are ON, the lens CPU 301 starts detection of shake by means of the shake sensor 308 (S147) and detection of the position of the movable unit by means of the position detector (S148). Then, the camera CPU 201 starts the autofocus and photometry operations (S149) as in S136. The lens CPU 301 then starts the second image stabilization control operation (S150). This second image stabilization operation allows an optically optimal image-pickup operation.

Upon determination that the SW2 is ON (S151), the camera CPU 201 performs the up operation of the quick return mirror 210, exposes the image-pickup element 207 (S139) and acquires a recording image and records it to the recording medium (S140). When the SW2 is OFF at S151, the operation returns to S145.

When the IS switch 303 is OFF at S146, the lens CPU 301 and the camera CPU 201 perform S152 to S154 as in S141 to S143, and when the SW2 is ON (S155), the operation proceeds to S139. When the SW2 is OFF at S155, the operation returns to S145.

As described above, according to this embodiment, in the low-quality image-pickup mode, the center of the image stabilization operation is the first position where the movable unit is slightly lowered due to its own weight from the optical axis center position in the gravity direction in both the image-pickup preparation stage (finder observation stage) and the image-pickup stage. Thus, power consumption required for lifting the movable unit to the optical axis center position can be eliminated, allowing a power-saving image stabilization operation.

Furthermore, according to the embodiments described above, in the first control operation, the power is not required for moving the center of the drive operation of the movable unit to the second position against the gravity, so that a power-saving image stabilization function can be achieved. Moreover, in the second control operation, the center of the drive operation of the movable unit is the second position that is shifted from the first position toward the optical axis of the optical system, so that image quality can be improved. Therefore, it is possible to select between the power saving-oriented image stabilization function and the image quality-oriented image stabilization function as required.

Although preferable embodiments of the present invention have been described above, the present invention is not limited thereto. Various variations and modifications can be made within the scope the present invention set forth in the appended claims.

Although the above embodiments have been described with reference to the single-lens reflex image-pickup system with an interchangeable lens, the present invention can be applied to other optical apparatuses, such as a digital still camera with a fixed lens and a video camcorder.

In the above embodiments, although the description has been made of a case where the shake sensor is provided in the interchangeable lens, the shake sensor may be provided in the camera and detected shake information may be transmitted to the interchangeable lens. Furthermore, a motion vector may be detected from images acquired from the image-pickup element, and information on the motion vector may be transmitted to the interchangeable lens as shake information.

In the above embodiments, the description has been made of a case where the image stabilization unit provided in the interchangeable lens is controlled and driven by the lens CPU provided in the same interchangeable lens. However, the camera CPU provided in the camera (optical apparatus) may control and drive the image stabilization unit provided in the interchangeable lens. In this case, the camera CPU is configured to include the functions of the lens CPU described above.

In the above embodiments, although the description has been made of the lens apparatus that drives the correction lens for image stabilization, the present invention can be applied to an image-pickup apparatus (optical apparatus) that drives a movable unit including an image-pickup element for picking up a subject image for image stabilization.

Furthermore, the present invention is not limited to these preferred embodiments and various variations and modifications may be made without departing from the scope of the present invention.

This application claims foreign priority benefits based on Japanese Patent Application No. 2005-356593, filed on Dec. 9, 2005, which is hereby incorporated by reference herein in its entirety as if fully set forth herein.

What is claimed is:

1. An optical apparatus comprising:
a movable unit which is supported by an elastic member and movable for image stabilization; and
a controller which controls drive of the movable unit,
wherein the controller performs a first control operation which controls drive of the movable unit with respect to a first position as the center of movement where the weight of the movable unit itself and a supporting force of the elastic member are balanced, and a second control operation which controls drive of the movable unit with respect to a second position as the center of movement, the second position being shifted from the first position in the direction opposite to the gravity direction toward the optical axis of an optical system that forms an object image.

2. The optical apparatus according to claim 1, wherein the movable unit includes an optical element, and
when the movable unit is at the second position, the center of the optical element coincides with the optical axis of the optical system.

3. The optical apparatus according to claim 1, wherein the controller performs the first control operation in an image-pickup preparation stage and performs the second control operation in an image-pickup stage.

4. The optical apparatus according to claim 1, wherein the controller performs the first control operation in a first mode intended to save power and performs the second control operation in a second mode different from the first mode.

5. The optical apparatus according to claim 1, wherein the controller performs the first control operation in a mode for acquiring images with first image quality and performs the second control operation in a mode for acquiring images with second image quality that is higher than the first image quality.

6. The optical apparatus according to claim 1, further comprising a shake sensor that detects shake of the optical apparatus,
wherein the controller drives the movable unit based on an output from the shake sensor.

7. The optical apparatus according to claim 1, further comprising an optical system including the movable unit,
wherein the optical apparatus is a lens apparatus which is detachably attached to an image-pickup apparatus that picks up object images formed by the optical system.

8. An image-pickup system comprising:
the lens apparatus according to claim 7; and
an image-pickup apparatus to which the lens apparatus is detachably attached.

9. The optical apparatus according to claim 1, wherein the optical apparatus is an image-pickup apparatus comprising an optical system including the movable unit and an image-pickup element that picks up object images formed by the optical system.
